(19) United States
(12) Patent Application Publication
(10) Pub. No.: US 2025/0158374 A1
(43) Pub. Date: May 15, 2025

(54) BURIED PIPE AND BURIED PIPE PROTECTION METHOD

(71) Applicant: NIPPON TELEGRAPH AND TELEPHONE CORPORATION, Tokyo (JP)

(72) Inventors: Daisaku NISHIYAMA, Tokyo (JP); Koji ITASAKA, Tokyo (JP); Takuya ISHIKAWA, Tokyo (JP); Akira ITO, Tokyo (JP)

(73) Assignee: NIPPON TELEGRAPH AND TELEPHONE CORPORATION, Tokyo (JP)

(21) Appl. No.: 18/836,578

(22) PCT Filed: Feb. 9, 2022
(86) PCT No.: PCT/JP2022/005200

§ 371 Date: Aug. 7, 2024

(51) Int. Cl. H02G 9/06; H02G 1/16

(52) U.S. Cl. CPC H02G 9/06; H02G 1/16

(57) ABSTRACT

The buried pipe 1 includes an inner pipe 11 capable of housing a cable 9, a protection member 12 disposed on the outer circumference of the inner pipe 11, and an outer pipe 10 housing the protection member 12 and the inner pipe 11. The protection member 12 has a higher strength than the inner pipe 11 and the outer pipe 10.

### TECHNICAL FIELD

The present disclosure relates to a buried pipe and a method of protecting a buried pipe.

### BACKGROUND ART

When various cables such as optical fibers and power transmission lines are buried in the ground, it is known to use buried pipes housing the cables. When the buried pipes are buried in the ground below roads or the like to form the buried pipelines, there is a high risk of the buried pipelines being damaged by excavation machines such as cutters or the like due to road construction or the like in shallow sections where earth coverings which are depths from the ground surfaces to the buried pipes cannot be sufficiently secured.

In order to prevent damage to the buried pipelines in the shallow sections, installing marking sheets indicating that the buried pipes are buried, or iron plates, ceramic plates, or metal plates for preventing entry of heavy machines between the ground surfaces and the buried pipes is known (Patent Literatures 1 to 3).

### CITATION LIST

### Patent Literature

Patent Literature 1: JP 2001-355758 A
Patent Literature 2: JP 2007-143355 A
Patent Literature 3: JP 2015-180166 A

### SUMMARY OF INVENTION

### Technical Problem

However, in configurations of the related art, it is difficult to secure separation from the ground surfaces to the buried pipes due to structures of topography, or strata, although spaces corresponding to the above sides of the buried pipes are required, and thus the buried pipeline may not be appropriately protected.

An object of the present disclosure is to provide a buried pipe capable of appropriately protecting a buried pipeline even when it is difficult to secure separation from the ground surface to the buried pipe, and a method of protecting the buried pipe.

### Solution to Problem

According to an embodiment, a buried pipe includes an inner pipe capable of housing a cable, a protection member disposed on an outer circumference of the inner pipe, and an outer pipe configured to house the protection member and the inner pipe. The protection member has a higher strength than the inner pipe and the outer pipe.

According to another embodiment, a method of protecting a buried pipe is a method of protecting a buried pipe that includes an outer pipe and performs protection. The method includes a step of disposing a protection member that has a higher strength than the inner pipe and the outer pipe on an outer circumference of the inner pipe capable of housing a cable and a step of housing the inner pipe in which the protection member is disposed on an outer circumference in the outer pipe.

### Advantageous Effects of Invention

According to the present disclosure, it is possible to appropriately protect the buried pipeline even when it is difficult to secure the separation from the ground surface to the buried pipe.

### BRIEF DESCRIPTION OF DRAWINGS

FIG. 1 is a sectional view illustrating a configuration example of a buried pipe according to an embodiment.

FIG. 2 is a side view illustrating a configuration example of a protection member of FIG. 1.

FIG. 3 is a sectional view illustrating another configuration example of the buried pipe according to the embodiment.

FIG. 4 is a side view illustrating a configuration example of a protection member of FIG. 3.

FIG. 5 is a side view illustrating a configuration example of a protection member according to an embodiment.

FIG. 6 is an enlarged view illustrating a protection member of FIG. 5.

FIG. 7 is a sectional view illustrating an example in which a multiple-cable housing portion is housed in an inner pipe of FIG. 3.

FIG. 8A is a sectional view illustrating an example of an outer pipe configured as a split pipe.

FIG. 8B is a sectional view illustrating an example of an outer pipe configured as a split pipe.

FIG. 9A is a sectional view illustrating an example of an inner pipe configured as a split pipe.

FIG. 9B is a sectional view illustrating an example of an inner pipe configured as a split pipe.

FIG. 10 is a flowchart illustrating a procedure of a method of protecting a buried pipe according to an embodiment.

### DESCRIPTION OF EMBODIMENTS

Hereinafter, an embodiment of the present disclosure will be described with reference to the drawings. In the drawings, portions that have the same configuration or function are denoted by the same reference signs. In description of the embodiment, repeated description of the same portions may be omitted or simplified as appropriate.

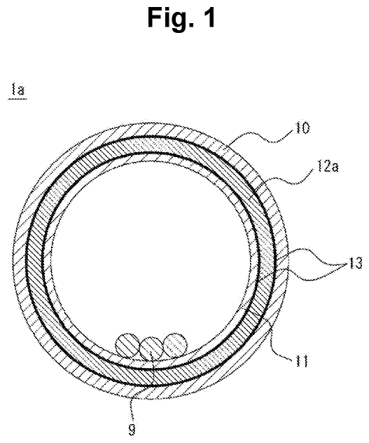

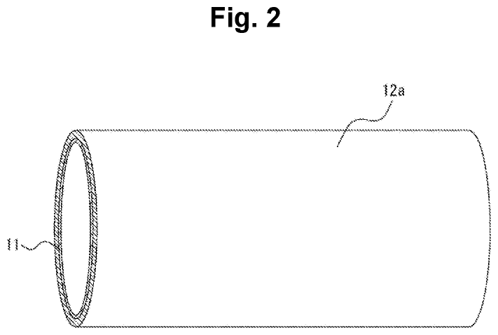

The present disclosure provides a configuration for protecting a buried pipeline in buried pipes 1 (1a, 1b, 1c), so that a protection space can be reduced more than in a configuration of the related art, and the buried pipeline can be protected even when it is difficult to secure separation (depth) from a road surface. FIG. 1 is a sectional view illustrating a configuration example of a buried pipe 1 (1a) according to an embodiment. The buried pipe 1a protects various cables 9 such as optical fibers and power transmission lines buried in the ground. FIG. 2 is a side view illustrating a configuration example of a protection member 12a in FIG. 1. The buried pipe 1a includes an inner pipe 11, the protection member 12a, and an outer pipe 10.

The inner pipe (cable protection pipe) 11 is a tubular member capable of housing the cable 9. The outer pipe 10 is a tubular member that houses the protection member 12a and the inner pipe 11. Both the inner pipe 11 and the outer pipe 10 can be made of an arbitrary material. For example, the inner pipe 11 and the outer pipe 10 may be made of a synthetic resin material such as rigid vinyl chloride containing calcium carbonate, polyethylene, polypropylene, and acrylonitrile butadiene rubber (ABS), or a material such as a metal containing steel. The outer pipe 10 may be fixed in the ground by a member such as a joint.

The protection member 12a is a member disposed on the outer circumference of the inner pipe 11. The protection member 12a has a higher strength than the inner pipe 11 and the outer pipe 10. The protection member 12a is made of any material that has a high strength and may be made of, for example, a ceramic such as titanium boride, tungsten, or the like. In this way, in the embodiment, by disposing the protection member 12a having a higher strength than the inner pipe 11 and the outer pipe 10 on the outer circumference of the inner pipe 11, it is possible to protect the cable 9 housed in the inner pipe 11 even when an excavation machine such as a cutter comes into contact with the buried pipe 1a. Accordingly, even when it is difficult to secure the separation from the ground surface to the buried pipe 1a, it is possible to appropriately protect the buried pipeline.

The surface of the protection member 12a may be coated with coating material 13. The coating material 13 is made of any material capable of protecting the surface of the protection member 12a. For example, the material of the coating material 13 may be an insulating resin such as fiber-reinforced plastics (FRP), a rubber material such as water-expanded rubber or styrene-butadiene rubber (SBR), an elastomer, or the like. As described above, by coating the surface of the protection member 12a with the coating material 13, it is possible to prevent scattering of the protection member 12a even when the protection member 12a is cracked.

It is known that when the conductive ceramic and the metal of the conductor come into contact with each other, a potential difference is generated between the conductive ceramic and the metal, and corrosion occurs in the metal. Thus, when at least one of the inner pipe 11 and the outer pipe 10 is a metal and the protection member 12a is a conductive ceramic, the coating material 13 may be an insulating material. Accordingly, the protection member 12a which is a conductive ceramic can be insulated from the inner pipe 11 and the outer pipe 10 which are metals, and thus it is possible to prevent corrosion of the inner pipe 11 or the outer pipe 10 due to contact between the inner pipe 11 and the outer pipe 10. For example, by using the above-mentioned FRP resin, rubber material or the like as the coating material 13, it is possible to effectively prevent corrosion of the inner pipe 11 or the outer pipe 10.

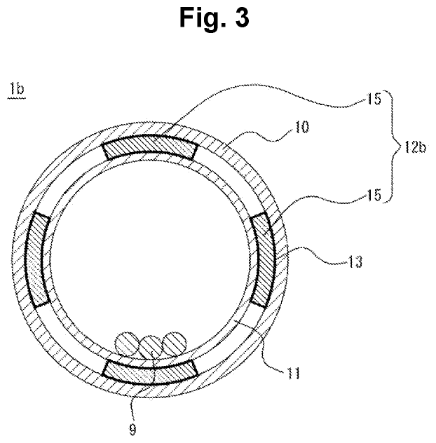

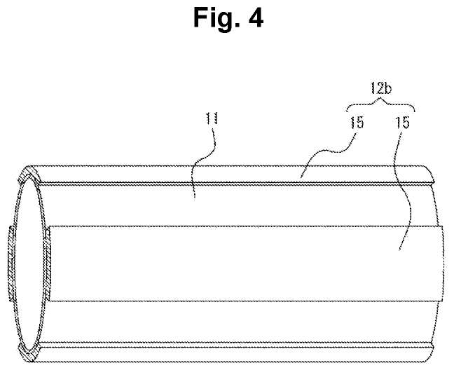

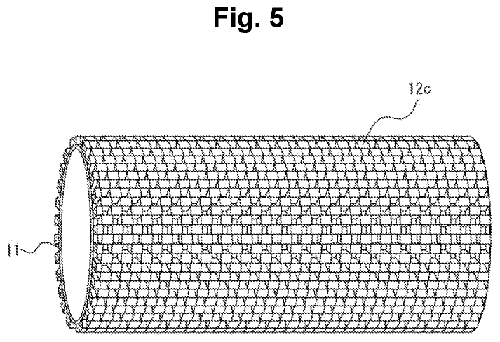

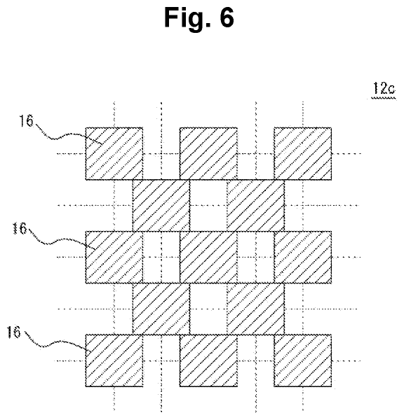

Although FIGS. 1 and 2 illustrate an example in which the entire surface of the inner pipe 11 is covered with the protection member 12a, a region that is not covered with the protection member 12 may be present in a part of the surface of the inner pipe 11. FIG. 3 is a sectional view illustrating a configuration example of the buried pipe 1b in which the protection member 12b is partially disposed on the surface of the inner pipe 11. FIG. 4 is a side view illustrating a configuration example of the protection member 12b in FIG. 3. FIGS. 3 and 4 illustrate an example in which the protection member 12b includes a plurality of rod-like bodies 15 arranged in parallel with the longitudinal direction of the inner pipe 11. FIGS. 3 and 4 illustrate an example in which the protection member 12b includes four rod-like bodies 15, but any number of rod-like bodies 15 can be used. FIG. 5 is a side view illustrating another configuration example of protection member 12c. FIG. 6 is an enlarged view illustrating the protection member 12c in FIG. 5. FIGS. 5 and 6 illustrate an example in which the protection member 12c includes a plurality of rectangular bodies 16 arranged in a lattice shape (a strip).

As illustrated in FIGS. 3 to 6, a part of the outer circumference of inner pipe 11 may have a region that is not covered with protection members 12b and 12c. In general, the protection member 12 made of ceramic or the like is more expensive than the inner pipe 11 or the outer pipe 10 in many cases. By disposing the protection members 12b and 12c partially on the surface of the inner pipe 11, it is possible to appropriately protect the buried pipeline while reducing the cost of the buried pipe 1 even when the protection member 12 is expensive. FIGS. 3 to 6 illustrate an example in which the protection member 12 is partially disposed on the surface of the inner pipe 11, but the disposition of the protection member 12 is not limited thereto. For example, the protection member 12 may be a plurality of annular (ring) bodies arranged at intervals on the surface of the inner pipe 11.

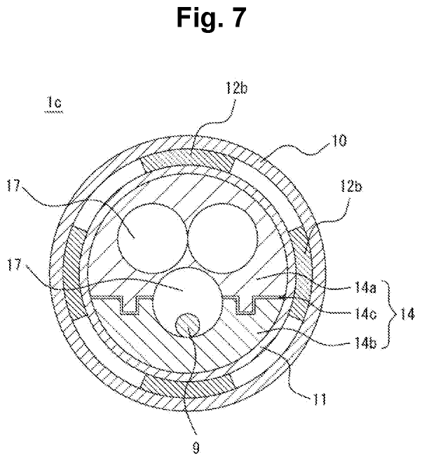

FIGS. 1 and 3 illustrate an example in which the inner pipe 11 directly houses the cable 9, but the inner pipe 11 may further house another structure capable of housing the cable 9. FIG. 7 is a sectional view illustrating an example in which the multiple-cable housing portion 14 is housed in the inner pipe 11 of FIG. 3. The multiple-cable housing portion 14 includes a plurality of housing spaces 17 for housing the cables 9. FIG. 7 illustrates an example in which the multiple-cable housing portion 14 includes three housing spaces 17. The multiple-cable housing portion 14 can be made of any material. For example, the multiple-cable housing portion 14 may be made of a synthetic resin material such as hard vinyl chloride containing calcium carbonate, polyethylene, polypropylene, and acrylonitrile butadiene rubber (ABS), or a material such as a metal containing steel. In this way, by housing the multiple-cable housing portion 14 including the plurality of housing spaces 17 in the inner pipe 11, the plurality of cables 9 can be housed in a plurality of groups separately. Further, as illustrated in FIG. 7, the multiple-cable housing portion 14 may be configured such that a first member 14a and a second member 14b can be separated along a boundary portion 14c. Accordingly, the cable 9 can be housed by separating the first member 14a from the second member 14b, and the cable 9 can be more easily housed in the multiple-cable housing portion 14. Any number of housing spaces 17 included in the multiple-cable housing portion 14, and any position and shape of the boundary portion 14c in the multiple-cable housing portion 14 can be used, and are not limited to those exemplified in FIG. 7.

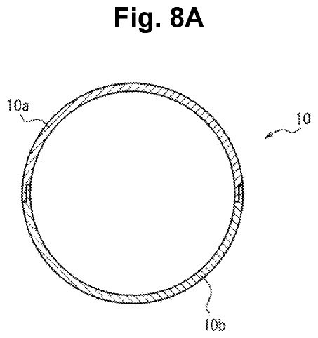

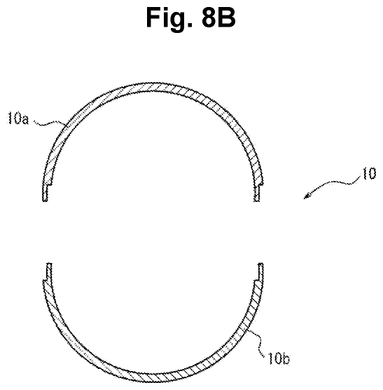

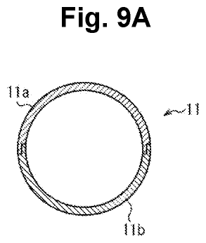

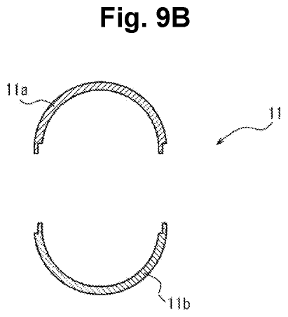

FIGS. 1, 3, and 7 illustrate a configuration example in which both the outer pipe 10 and the inner pipe 11 have a continuous circular cross section, but the outer pipe 10 and the inner pipe 11 may have a split-pipe structure in which an upper half portion and a lower half portion can be separated. FIGS. 8A and 8B are sectional views illustrating an example of the outer pipe 10 configured as a split pipe. In the outer pipe 10, an upper portion 10a and a lower portion 10b can be separated. FIGS. 9A and 9B are sectional views illustrating an example of the inner pipe 11 configured as a split pipe. In the inner pipe 11, an upper portion 11a and a lower portion 11b can be separated. When the outer pipe 10 and the inner pipe 11 have such a split-pipe structure, the buried pipe 1 can be easily installed, and partial replacement can be performed in repair. Therefore, it is possible to improve workability. The split-pipe structures of the outer pipe 10 and the inner pipe 11 may be not only a structure in which the upper portion and the lower portion of the buried pipe 1 can be separated, but also other structures as long as a housed object can be easily taken in and out. For example, the split-pipe structure of the outer pipe 10 and the inner pipe 11 may be a structure in which the buried pipe 1 can be separated in a vertical plane. The split-pipe structures of the outer pipe 10 and the inner pipe 11 may be separable in all portions of the buried pipe 1 or may be separable only in a part of the buried pipe 1.

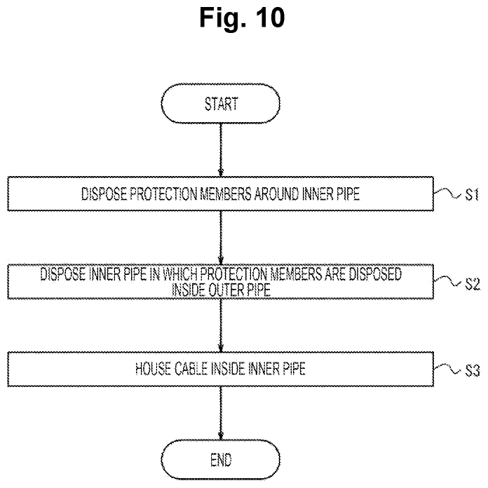

FIG. 10 is a flowchart illustrating a procedure of a method of protecting the buried pipe 1 according to an embodiment. In the protection method according to the embodiment, by constructing a protection structure for protecting the cable 9 in the buried pipe 1, it is possible to further reduce a protection space than in a configuration of the related art and protect the buried pipe 1 even when it is difficult to secure the separation (depth) from a road surface.

In step S1, the protection members 12 (12a, 12b, and 12c) are disposed around the inner pipe 11. For example, when the protection member 12a has a cylindrical shape having a hollow portion as illustrated in FIGS. 1 and 2, the inner pipe 11 may be housed in the hollow portion of protection member 12. For example, as illustrated in FIGS. 3 and 4, when the protection member 12b includes a plurality of rod-like bodies 15, the plurality of rod-like bodies 15 may be arranged in parallel in the longitudinal direction on the surface of the inner pipe 11. For example, as illustrated in FIGS. 5 and 6, when the protection members 12c include a plurality of rectangular bodies 16 arranged in a lattice shape, the plurality of rectangular bodies 16 may be wound around the outer circumference of the inner pipe 11.

In step S2, the inner pipe 11 in which the protection member 12 (12a, 12b, and 12c) are disposed is disposed inside the outer pipe 10. For example, inner pipe 11 in which protection members 12 (12a, 12b, and 12c) are disposed is inserted into the hollow portion of the outer pipe 10.

In step S3, the cable 9 is housed inside the inner pipe 11. Then, the process of the flowchart ends.

Through the foregoing steps, the buried pipe 1 that has the protection structure for protecting the cable 9 can be configured. In implementation, the order of the foregoing steps may be changed.

In each embodiment of the present disclosure, by constructing the protection structure in the buried pipe 1, it is not necessary to provide another member between the ground surface and the buried pipe 1, and the cable 9 can be protected from an excavation machine such as a cutter. Therefore, the buried pipe 1 can be applied even when it is difficult to secure separation from a road surface, and it is also possible to achieve space saving in the upper portion of the buried pipe 1.

The present disclosure is not limited to the above-described embodiment, and modifications can be made without departing from the gist of the present disclosure.

### REFERENCE SIGNS LIST

1a, 1b, 1c Buried pipe
9 Cable
10 Outer pipe
11 Inner pipe
12a, 12b, 12c Protection member
13 Coating material
14 Multiple-cable housing portion
15 Rod-like body
16 Rectangular body

1. A buried pipe comprising:
an inner pipe capable of housing a cable;
a protection member disposed on an outer circumference of the inner pipe; and
an outer pipe configured to house the protection member and the inner pipe,
wherein the protection member has a higher strength than the inner pipe and the outer pipe.

2. The buried pipe according to claim 1, wherein a surface of the protection member is coated with a coating material.

3. The buried pipe according to claim 2,
wherein at least one of the inner pipe and the outer pipe is made of metal,
the protection member is a conductive ceramic, and
the coating material is an insulating material.

4. The buried pipe according to claim 3, wherein the coating material is an insulating resin or a rubber material.

5. The buried pipe according to claim 1, wherein a part of an outer circumference of the inner pipe has an area that is not covered with the protection member.

6. The buried pipe according to claim 5, wherein the protection member includes a plurality of rod-like bodies arranged in parallel in a longitudinal direction of the inner pipe or a plurality of rectangular bodies arranged in a lattice shape.

7. A method of protecting a buried pipe that includes an outer pipe and performs protection, the method comprising:
disposing a protection member that has a higher strength than the inner pipe and the outer pipe on an outer circumference of the inner pipe capable of housing a cable; and
housing the inner pipe in which the protection member is disposed on an outer circumference in the outer pipe.

8. The method of protecting a buried pipe according to claim 7, wherein a surface of the protection member is coated with a coating material.

9. The method of protecting a buried pipe according to claim 8,
wherein at least one of the inner pipe and the outer pipe is made of metal,
the protection member is a conductive ceramic, and
the coating material is an insulating material.

10. The method of protecting a buried pipe according to claim 9, wherein the coating material is an insulating resin or a rubber material.

11. The method of protecting a buried pipe according to claim 7, wherein a part of an outer circumference of the inner pipe has an area that is not covered with the protection member.

12. The method of protecting a buried pipe according to claim 11, wherein the protection member includes a plurality of rod-like bodies arranged in parallel in a longitudinal direction of the inner pipe or a plurality of rectangular bodies arranged in a lattice shape.
